(19) United States
(12) Patent Application Publication
(10) Pub. No.: US 2014/0151592 A1
(43) Pub. Date: Jun. 5, 2014

(54) BUTTERFLY VALVE AND METHOD OF CHECKING FOR LEAKS IN THE SAME

(71) Applicant: SAMSUNG DISPLAY CO., LTD., Yongin-city (KR)

(72) Inventor: Jae-Dong Ha, Yongin-city (KR)

(73) Assignee: Samsung Display Co., Ltd., Yongin-city (KR)

(21) Appl. No.: 13/829,751

(22) Filed: Mar. 14, 2013

(30) Foreign Application Priority Data
Dec. 5, 2012 (KR) 10-2012-0140514

(51) Int. Cl. G01M 3/22; F16K 1/226

(52) U.S. Cl. CPC G01M 3/224; F16K 1/226
USPC 251/306; 73/40.7

(57) ABSTRACT

A butterfly valve is disclosed. In one aspect, the butterfly valve includes a pipe-shaped housing, a valve disk rotatably arranged within the pipe-shaped housing, a space forming member formed along an outer circumference of the valve disk, and a leak check port provided in the housing and configured to be connected to a space between the space forming member and the housing.

### CROSS-REFERENCE TO RELATED PATENT APPLICATION

This application claims the benefit of Korean Patent Application No. 10-2012-0140514, filed on Dec. 5, 2012, in the Korean Intellectual Property Office, the disclosure of which is incorporated herein in its entirety by reference.

### BACKGROUND

1. Field

The described technology generally relates to a butterfly valve.

2. Description of the Related Technology

Generally, a manufacturing process of a semiconductor, a liquid crystal display (LCD), an organic light emitting diode (OLED) display, etc., is achieved by repeatedly performing a variety of sub-processes such as developing, etching, diffusion, chemical vapor deposition, and metal deposition. Each sub-process requires a semiconductor specific environmental condition according to design, and many of them are performed in a vacuum.

### SUMMARY

One inventive aspect is a butterfly valve for checking for a leak stand alone. Another aspect is a butterfly valve including: a pipe-shaped housing; a valve disk rotatably arranged within the pipe-shaped housing; a space forming member formed along an outer circumference of the valve disk; and a leak check port provided in the pipe-shaped housing and opening up to a space between the space forming member and the pipe-shaped housing.

The space forming member may include two or more o-rings. The space forming member may include a first o-ring and a second o-ring. The butterfly valve may further include a sealing member to seal off the leak check port by being coupled with the leak check port.

The butterfly valve may further include a leak detector connected to the leak check port. The leak detector may include a helium leak detector. The first o-ring and the second o-ring may be formed in parallel to each other along the outer circumference of the valve disk.

A first groove and a second groove may be formed along the outer circumference of the valve disk, the first o-ring may be inserted into the first groove, and the second o-ring may be inserted into the second groove. The first groove and the second groove may be formed in parallel to each other along the outer circumference of the valve disk, and the first o-ring and the second o-ring may be formed in parallel to each other along the outer circumference of the valve disk.

The leak check port may open up to a space formed by the first o-ring, the second o-ring, the valve disk and the pipe-shaped housing in a state where the first o-ring and the second o-ring are in close contact with the pipe-shaped housing.

Another aspect is a method of checking for a leak in a butterfly valve composed of a pipe-shaped housing and a valve disk rotatably arranged within the pipe-shaped housing, including: providing a space forming member formed along an outer circumference of the valve disk; providing a leak check port in the pipe-shaped housing in order to so that the leak check port opens up to a space between the space forming member and the pipe-shaped housing; closing the butterfly valve by rotating the valve disk; connecting one end of the leak check port to a leak detector; using the leak detector to create a vacuum within the space between the space forming member and the pipe-shaped housing; spraying a test gas toward the space forming member; and detecting for the test gas by using the leak detector.

The space forming member may include two or more o-rings. The space forming member may include a first o-ring and a second o-ring. The one end of the leak check port may be connected to the leak detector through a pipe. The method may further include sealing off the leak check port after separating the leak detector from the one end of the leak check port.

The leak detector may be a helium leak detector, the sprayed test gas is a helium gas, and the helium gas is detected for by a helium leak detector. The first o-ring and the second o-ring may be formed in parallel to each other along the outer circumference of the valve disk. A first groove and a second groove may be formed along the outer circumference of the valve disk, the first o-ring may be inserted into the first groove, and the second o-ring may be inserted into the second groove.

The first groove and the second groove may be formed in parallel to each other along the outer circumference of the valve disk, and the first o-ring and the second o-ring may be formed in parallel to each other along the outer circumference of the valve disk. The leak check port may open up to a space formed by the first o-ring, the second o-ring, the valve disk and the pipe-shaped housing in a state where the first o-ring and the second o-ring are in close contact with the pipe-shaped housing.

### BRIEF DESCRIPTION OF THE DRAWINGS

FIG. 1 is a front view schematically illustrating a butterfly valve in a closed state according to an exemplary embodiment.

FIG. 2 is a front view schematically illustrating a butterfly valve in an open state according to an exemplary embodiment.

FIG. 3 is across-sectional view schematically illustrating a section that is cut along Ea-III of FIG. 1.

FIG. 4 is an enlarged cross-sectional view schematically illustrating part of the butterfly valve illustrated in FIG. 3.

FIG. 5 is an enlarged cross-sectional view schematically illustrating part of a butterfly valve according to another exemplary embodiment.

FIG. 6 is an enlarged cross-sectional view schematically illustrating part of a butterfly valve according to further another exemplary embodiment.

FIG. 7 is a flowchart illustrating a method of checking a leak in a butterfly valve according to an exemplary embodiment.

### DETAILED DESCRIPTION

Generally, a vacuum line is connected to a process chamber, and the manufacturing processes are performed in the process chamber while the process chamber is in a vacuum state. The process chamber is connected to an external exhaust pump. Further, a butterfly valve connected to a pump for maintaining a vacuum state and removing particles is installed in each of the chambers so as to open/close a seal of a process chamber in a vacuum state.

Such a butterfly valve is mainly electrically operated, and the butterfly valve includes a valve disk for regulating operation of pressure adjustment and an actuator for rotating the valve disk. Further, when a process is performed in the process chamber, the butterfly valve is generally operated between the process chamber and the pump.

Further, the butterfly valve is located between a pump piping line and a process chamber in order to perform a complete isolation function, thus enabling the process to be performed in the process chamber. That is, there should be no leak in the butterfly valve itself. However, the butterfly valve may be examined for leaks only when all conditions are satisfied after the butterfly valve has been assembled in the equipment.

The disclosed embodiments may be modified in various ways. The present invention is not limited to the disclosed embodiments covers all modifications, equivalents and substitutes to the disclosed embodiments.

Terms such as “first” and “second” may be used to describe various components, but the components should not be limited by such terms. The terms are used only to distinguish one component from another component.

The terms used in the present specification are used only to explain certain embodiments, but are not used to limit the scope of rights of the present invention. A singular expression includes a plurality of expressions unless clearly stated or implied otherwise. In the present specification, the terms such as “include” and “have” are used to indicate that characteristics, numbers, steps, operations, components, parts or combinations thereof disclosed in the present invention exist, but such terms do not exclude the possibility of existence or addition of one or more other characteristics, numbers, steps, operations, components, parts or combinations thereof.

Hereinafter, embodiments will be described in detail with reference to the attached drawings.

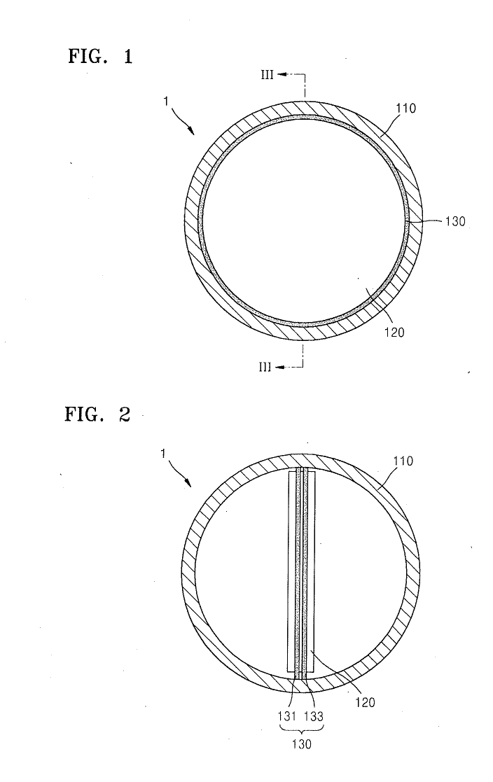

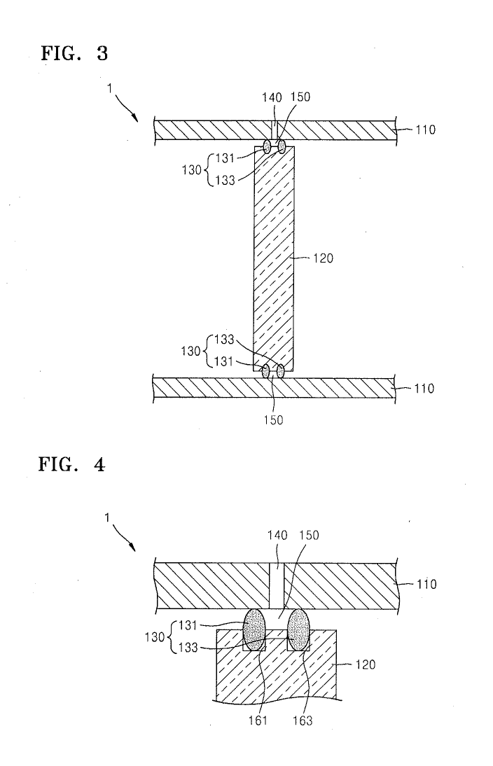

FIG. 1 is a front view schematically illustrating a butterfly valve in a closed state according to an exemplary embodiment. FIG. 2 is a front view schematically illustrating a butterfly valve in an open state according to an exemplary embodiment. FIG. 3 is a cross-sectional view schematically illustrating a section which is cut along III-III of FIG. 1.

A butterfly valve 1 illustrated in FIGS. 1, 2 and 3 may be checked for a leak before assembling the butterfly valve 1 in a piece of equipment.

The butterfly valve 1 may include a housing 110, a valve disk 120, a space forming member 130 and a leak check port 140.

The valve disk 120 may be rotatably arranged within the housing 110. The space forming member 130 may be formed along the outer circumference of the valve disk 120. The leak check port 140 may be provided in the housing 110. Further, the leak check port 140 may open up to (or may be connected to) a space between the space forming member 130 and the housing 110. The leak check port 140 may be in fluid (e.g., gas) communication with the space between the space forming member 130 and the housing 110.

The valve disk 120 may open or close the butterfly valve 1 while being rotated within the housing 110. The space forming member 130 may form a space 150 between the space forming member 130 and the housing 110 when the butterfly valve 1 is in a closed state. The leak check port 140 may open up to a space between the space forming member 130 and the housing 110. As such, the butterfly valve 1 illustrated in FIGS. 1, 2 and 3 may be checked for a leak before assembling the butterfly valve 1 in the equipment.

The housing 110 may be pipe-shaped. Further, the housing may be formed of metal materials. The valve disk 120 may have a round plate shape, and may be formed of metal materials.

The valve disk 120 may be rotated in various manners within the housing 110. For example, a shaft (not shown) may be coupled with one side of the valve disk 120. The shaft may be connected to a driving unit (not shown). Hence, the shaft may be rotated by the driving unit, and as the shaft is rotated, the valve disk 120 coupled with the shaft may be rotated.

As shown in FIG. 1, when the surface of the valve disk 120 is substantially perpendicular to the vertical axis of the housing 110, the butterfly valve 1 is closed. In contrast, as shown in FIG. 2, when the surface of the valve disk 120 is not substantially perpendicular to the vertical axis of the housing 110, the butterfly valve 1 is opened. That is, the butterfly valve 1 may open/close a vacuum seal by the rotation of the valve disk 120.

The space forming member 130 may be formed along the outer circumference of the valve disk 120. The space forming member 130 may include a first o-ring 131 and a second o-ring 133.

The first o-ring 131 and the second o-ring 133 may be formed in substantially parallel to each other along the outer circumference of the valve disk 120. Further, the sections of the o-rings 131 and 133 are substantially round and ring-shaped and may be formed of elastic materials. The o-rings 131 and 133 may fill a gap between the valve disk 120 and the housing 110. Hence, when the butterfly valve 1 is in a closed state, the first o-ring 131 and the second o-ring 133 may be in close contact with the housing 110.

As the first and second o-rings 131 and 133 are formed along the outer circumference of the valve disk 120, then, when the butterfly valve 1 is in a closed state, a space 150 may be formed between the first o-ring 131, the second o-ring 133, the housing 110 and the valve disk 120.

The leak check port 140 may be provided in the housing 110. Further, the leak check port 140 may open up to the space 150 formed by the first o-ring 131, the second o-ring 133, the housing 110 and the valve disk 120 when the butterfly valve 1 is in a closed state, that is, the two o-rings 131 and 133 are in close contact with the housing 110. Hence, when the butterfly valve 1 is in a closed state, the state of the space 150 formed by the first o-ring 131, the second o-ring 133, the housing 110 and the valve disk 120 may be changed or checked through the leak check port 140.

FIG. 4 is an enlarged cross-sectional view schematically illustrating part of the butterfly valve 1 illustrated in FIG. 3. Here, the same reference number refers to the same element for performing the same function in the drawings.

Referring to FIG. 4, a first groove 161 and a second groove 163 may be formed in the valve disk 120. The first groove 161 and the second groove 163 may be formed along the outer circumference of the valve disk 120. Further, the first and second grooves 161 and 163 may be formed in substantially parallel to each other along the outer circumference of the valve disk 120.

The first o-ring 131 may be inserted into the first groove 161, and the second o-ring 133 may be inserted into the second groove 163. Hence, when the two grooves 161 and 163 are formed in substantially parallel to each other along the outer circumference of the valve disk 120, the first o-ring 131 and the second o-ring 133 may also be formed in substantially parallel to each other along the outer circumference of the valve disk 120.

The leak check port 140 may open up to the space 150 formed by the first o-ring 131, the second o-ring 133, the housing 110 and the valve disk 120.

Further, it was explained in FIG. 4 that the space forming member 130 includes the first o-ring 131 and the second o-ring 133, and a space 150 is formed between the space forming member 130 and the housing 110, but the present invention is not limited to this example. The space forming member 130 may be formed in various shapes and of various materials, and a space may be formed between the space forming member 130 and the housing 110.

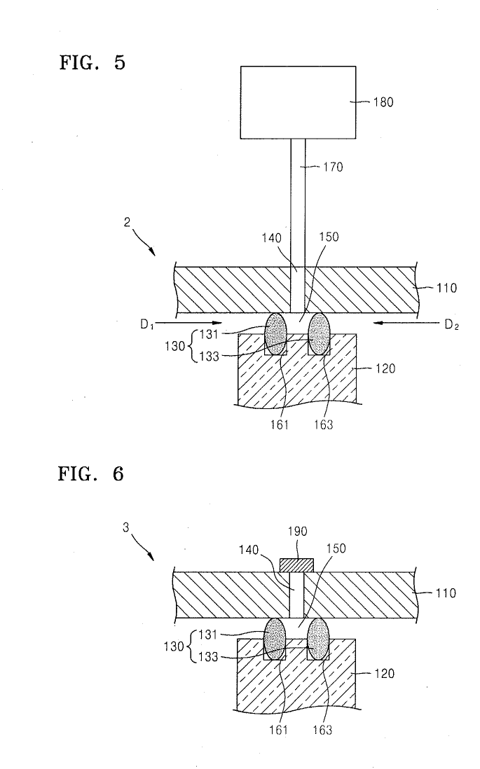

FIG. 5 is an enlarged cross-sectional view schematically illustrating part of a butterfly valve 2 according to another exemplary embodiment. Here, the same reference numbers refers to the same elements for performing the same functions in the drawings. Hereinafter, the present embodiment will be described, centering on the differences between the present embodiment and the embodiment of FIG. 4.

The leak check port 140 may be connected to a leak detector 180. The leak check port 140 and the leak detector 180 may be connected by a pipe 170. The pipe 170 may include a bellows.

The leak detector 180 may be connected to the leak check port 140, and the leak check port 140 may be connected to the space 150 formed by the first o-ring 131, the second o-ring 133, the housing 110 and the valve disk 120 when the butterfly valve 1 is in a closed state, that is, the o-rings 131 and 133 are in close contact with the housing 110.

The leak detector 180 may be connected to the space 150, and thus the leak detector 180 may create a vacuum in the space 150. After a vacuum is created in the space 150 by the leak detector 180, a test gas (probe gas) may be sprayed in a direction D1 toward the first o-ring 131 or in a direction D2 toward the second o-ring 133.

After the test gas (probe gas) is sprayed in the direction D1 toward the first o-ring 131 or in the direction D2 toward the second o-ring 133, the leak detector 180 may detect the test gas (probe gas). If the leak detector 180 detects the test gas (probe gas), this means that the test gas (probe gas) exists in the space 150. Hence, if the leak detector 180 detects the test gas (probe gas), this means that the test gas (probe gas), which has been sprayed in the direction D1 toward the first o-ring 131 or in the direction D2 toward the second o-ring 133, flows into the space 150. Thus it means that a leak has occurred in the butterfly valve 2. In contrast, if the test gas (probe gas) is not detected in the leak detector 180, it means that a leak has not occurred in the butterfly valve 2. Hence, the leak in the butterfly valve may be checked based on whether the test gas (probe gas) has been detected in the leak detector 180, and thus the leak in the butterfly valve 2 may be checked before assembling the butterfly valve 2 in the equipment. As such, the vacuum equipment may be efficiently maintained and repaired.

The leak detector 180 may include a helium leak detector. In this case, a helium gas is used as the test gas (probe gas). In this case, the butterfly valve 2 may be checked stand-alone for leaks by checking whether the helium gas has been detected by the helium leak detector.

FIG. 6 is an enlarged cross-sectional view schematically illustrating part of a butterfly valve 3 according to yet another exemplary embodiment. Here, the same reference numbers refers to the same elements for performing the same functions in the drawings. Hereinafter, the present embodiment will be described, centering on the differences between the present embodiment and the embodiment of FIG. 4.

The butterfly valve 3 may further include a sealing member 190. The sealing member 190 may be coupled with the leak check port 140 so as to seal off the leak check port 140. Consequently, as the leak check port 140 is sealed off by the sealing member 190, the leak check port 140 is isolated from the outside of the housing 110. The sealing member 190 may include a bolt.

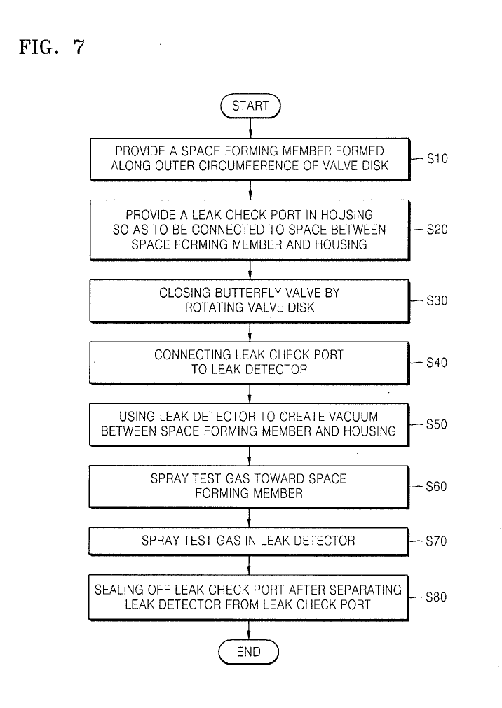

FIG. 7 is a flowchart illustrating a method of checking a leak in a butterfly valve according to an exemplary embodiment. Referring to FIG. 7, the leak in the butterfly valve may be checked through a step of providing a space forming member formed along the outer circumference of a valve disk (S10), a step of providing a leak check port in the housing so that the leak check port may open up to the space between the space forming member and the housing (S20), a step of closing the butterfly valve by rotating the valve disk (S30), a step of connecting the leak check port to the leak detector (S40), a step of using the leak detector to create a substantially vacuum state within the space between the space forming member and the housing (S50), a step of spraying a test gas toward the space forming member (S60), a step of detecting for the test gas by using the leak detector (S70), and a step of sealing off the leak check port after separating the leak detector from the leak check port (S80). In one embodiment, the “substantially vacuum state” includes a vacuum state, a state similar to or very close to the vacuum state, or a state similar to or approximate to the vacuum.

As described above, the butterfly valve may be checked stand-alone for leaks according to whether the test gas has been detected in the step of detecting for the test gas by using the leak detector (S70), and thus the butterfly valve may be checked for leaks before assembling the butterfly valve in the equipment. As such, the vacuum equipment may be efficiently maintained and repaired.

According to at least one of the disclosed embodiments, a butterfly valve may be checked for leaks even before the butterfly valve is assembled in the equipment.

While the above embodiments have been described with reference to the accompanying drawings; it will be understood by those of ordinary skill in the art that various changes in form and details may be made therein without departing from the spirit and scope of the present invention as defined by the following claims.

What is claimed is:

1. A butterfly valve comprising:
a pipe-shaped housing;
a valve disk rotatably arranged within the pipe-shaped housing;
a space forming member formed along an outer circumference of the valve disk; and
a leak check port formed in the pipe-shaped housing and configured to be connected to the space between the space forming member and the pipe-shaped housing.

2. The butterfly valve of claim 1, wherein the space forming member comprises a plurality of o-rings.

3. The butterfly valve of claim 1, wherein the space forming member includes a first o-ring and a second o-ring.

4. The butterfly valve of claim 3, wherein the first o-ring and the second o-ring are formed in substantially parallel to each other along the outer circumference of the valve disk.

5. The butterfly valve of claim 3, wherein a first groove and a second groove are formed along the outer circumference of the valve disk, wherein the first o-ring is inserted into the first groove, and wherein the second o-ring is inserted into the second groove.

6. The butterfly valve of claim 5, wherein the first and second grooves are formed in substantially parallel to each other along the outer circumference of the valve disk, and wherein the first and second o-rings are formed in substantially parallel to each other along the outer circumference of the valve disk.

7. The butterfly valve of claim 6, wherein the leak check port is configured to be connected to a space formed by the first o-ring, the second o-ring, the valve disk and the pipe-shaped housing in a state where the first and second o-rings are in close contact with the pipe-shaped housing.

8. The butterfly valve of claim 1, further comprising:
a sealing member configured to seal off the leak check port by being coupled with the leak check port.

9. The butterfly valve of claim 1, further comprising:
a leak detector connected to the leak check port.

10. The butterfly valve of claim 9, wherein the leak detector comprises a helium leak detector.

11. A method of checking for a leak in a butterfly valve comprising a pipe-shaped housing and a valve disk rotatably arranged within the pipe-shaped housing, the method comprising:
providing a space forming member formed along an outer circumference of the valve disk;
providing a leak check port in the pipe-shaped housing so that the leak check port is connected to the space between the space forming member and the pipe-shaped housing;
closing the butterfly valve by the rotation of the valve disk;
connecting one end of the leak check port to a leak detector;
creating a substantially vacuum state, with the use of the leak detector, within the space between the space forming member and the pipe-shaped housing;
spraying a test gas toward the space forming member; and
detecting the test gas with the use of the leak detector.

12. The method of claim 11, wherein the space forming member comprises a plurality of o-rings.

13. The method of claim 11, wherein the space forming member comprises a first o-ring and a second o-ring.

14. The method of claim 13, wherein the first and second o-rings are formed in parallel to each other along the outer circumference of the valve disk.

15. The method of claim 13, wherein a first groove and a second groove are formed along the outer circumference of the valve disk, wherein the first o-ring is inserted into the first groove, and wherein the second o-ring is inserted into the second groove.

16. The method of claim 15, wherein the first and second grooves are formed in substantially parallel to each other along the outer circumference of the valve disk, and wherein the first and second o-rings are formed in substantially parallel to each other along the outer circumference of the valve disk.

17. The method of claim 16, wherein the leak check port is connected to a space formed by the first o-ring, the second o-ring, the valve disk and the pipe-shaped housing in a state where the first and second o-rings are in close contact with the pipe-shaped housing.

18. The method of claim 11, wherein the one end of the leak check port is connected to the leak detector through a pipe.

19. The method of claim 11, further comprising:
sealing off the leak check port after separating the leak detector from the one end of the leak check port.

20. The method of claim 11, wherein the leak detector is a helium leak detector, wherein the sprayed test gas is a helium gas, and wherein the helium gas is detected by the helium leak detector.
